(19) United States
(12) Patent Application Publication
(10) Pub. No.: US 2010/0171412 A1
(43) Pub. Date: Jul. 8, 2010

(54) COMPOSITION CONTAINING INORGANIC PARTICLE, METHOD FOR FORMATION OF INORGANIC LAYER, AND PLASMA DISPLAY PANEL

(76) Inventors: Hiroyuki Tanaka, Ibaraki (JP); Yuuji Kobayashi, Ibaraki (JP); Naoki Yamada, Ibaraki (JP); Hiromi Kobayashi, Ibaraki (JP); Shoko Sugawara, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/601,315

(22) PCT Filed: May 28, 2008
(86) PCT No.: PCT/JP2008/059820

§ 371 Date: Nov. 23, 2009

(30) Foreign Application Priority Data
May 30, 2007 (JP) 2007-144021

(51) Int. Cl. H01J 63/04; B05D 5/06; C09D 5/25; H01J 9/00

(52) U.S. Cl. 313/484; 427/71; 252/301.36; 445/24

(57) ABSTRACT

A composition containing an inorganic particle of the present invention contains an organic compound (A1) having a terpene skeleton and a viscosity of 10,000 to 1,000,000 mPa·s at 25° C. and an inorganic particle, in which the content of the organic compound (A1) is 50% by mass to 95% by mass relative to the whole amount of organic compounds contained in the composition containing an inorganic particle.

### TECHNICAL FIELD

The present invention relates to a composition containing an inorganic particle, a method of formation of an inorganic layer and a plasma display panel.

### BACKGROUND ART

As a flat display, a plasma display panel (hereinafter described as “PDP”) is known, enabling to display multiple colors by providing phosphor layers which emit light by plasma discharge. In the PDP, a flat front panel and a back panel of glass are arranged mutually in parallel so as to face each other and they are kept at a predetermined distance by a barrier rib provided between them. Discharge is made in the space surrounded by the front panel, back panel and barrier rib. In this space, an electrode, a dielectric layer, a phosphor layer, etc. for display are provided. When discharge is made, the gas enclosed therein emits UV rays, which excites phosphors to emit light visible by an observer.

In the meantime, the electrode, dielectric layer or phosphor layer mentioned above is conventionally manufactured as follows. First, as a material for an electrode, a dielectric substance or a phosphor, a solution in the state of slurry or paste is prepared by dispersing a metal or metal oxide particle, a glass particle such as a dielectric glass frit or a phosphor particle separately in a mixture of an organic polymer binder and a solvent. Then, the resultant solution is applied onto a glass substrate by a coating method such as screen printing or die coating, and thereafter the coating film is sintered to remove organic substances such as a resin component to obtain the electrode, dielectric layer or phosphor layer (see, for example, Patent Document 1).

Patent Document 1: Japanese Patent Application Laid-Open No. 11-349349

### DISCLOSURE OF THE INVENTION

### Problems to be Solved by the Invention

The organic polymer binder used in the aforementioned method is effective for forming a good coating film but has the following problems. To describe more specifically, a large amount of energy is required since high temperature is required for decomposing an organic polymer binder. Also, there is a problem in that when an organic polymer binder is used, decomposition products are deposited on the inner wall of an electric furnace. Furthermore, there is a problem in that when an organic polymer binder is carbonized during decomposition and remains, air bubbles and bulge are formed, which are gradually vaporized during discharge, affecting discharge characteristics in some cases.

The present invention was attained under the above circumstances. An object of the present invention is to provide a composition containing an inorganic particle capable of not only forming a desired inorganic body or an inorganic layer with less energy than ever but also reducing an adverse effect derived from organic compounds. Another object of the present invention is to provide a method of formation of an inorganic layer using the composition containing an inorganic particle and a plasma display having an inorganic layer formed by the method of formation of an inorganic layer.

### Means for Solving the Problems

A first composition containing an inorganic particle of the present invention for attaining the above objects is a composition containing an inorganic particle, which contains an organic compound (A1) having a terpene skeleton and a viscosity of 10,000 to 1,000,000 mPa·s at 25° C., and an inorganic particle, characterized in that the content of the organic compound (A1) is 50% by mass to 95% by mass relative to the whole amount of organic compounds contained in the composition containing an inorganic particle.

Note that, in the present invention, “having a terpene skeleton” means having a structure containing a multiple number of isoprene units.

The viscosity of an organic compound in the present invention can be measured, for example, by a method in accordance with JIS Z 8803 or JIS K7117 at 25° C.

According to the composition containing an inorganic particle of the present invention, a good coating film can be formed by virtue of the above constitution. In addition, since the organic compound (A1) having a terpene skeleton can be removed at a relatively low temperature, the content of the organic compounds can be reduced than ever at the time of sintering the coating film. Therefore, according to the composition containing an inorganic particle of the present invention, a desired inorganic body or inorganic layer can be formed with less energy than ever and an adverse effect derived from organic compounds can be reduced. In addition, the amount of decomposition products deposited on the inner wall of an electric furnace can be also reduced. Note that if the content of the organic compound (A1) is less than 50% by mass relative to the whole amount of organic compounds contained in the composition containing an inorganic particle, it becomes difficult to form a good coating film; whereas, when the content exceeds 95% by mass, it becomes difficult to perform coating.

In the first composition containing an inorganic particle of the present invention, the organic compound is preferably isobornyl cyclohexanol represented by the structural formula (1) below because the viscosity of the composition is easily set within a suitable range.

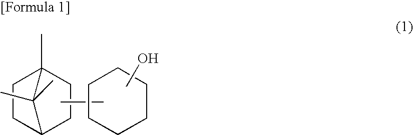

Furthermore, in the first composition containing an inorganic particle of the present invention, preferably, the organic compounds contained in the composition containing an inorganic particle provides a heating residue of not more than 1% by mass when heated at 300° C. for 10 minutes. In this case, an adverse effect derived from organic compounds can be further reduced in the inorganic body or inorganic layer obtained by sintering.

Furthermore, a second composition containing an inorganic particle of the present invention for attaining the above objects is a composition containing an inorganic particle that contains an organic compound (A2) having a viscosity of 10,000 to 1,000,000 mPa·s at 25° C. and providing a heating residue of not more than 1% by mass when heated at 300° C. for 10 minutes, and an inorganic particle, characterized in that the content of the organic compound (A2) is 50% by mass to 95% by mass relative to the whole amount of organic compounds contained in the composition containing an inorganic particle.

The first and second composition containing an inorganic particles of the present invention preferably further contain a compound represented by the general formula (2) below.

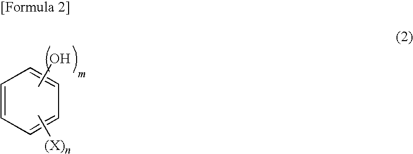

In the formula (2), X represents a halogen atom, a hydrogen atom, an alkyl group having 1 to 20 carbon atoms, a cycloalkyl group having 3 to 10 carbon atoms, an aryl group such as a phenyl group or naphthyl group that may be substituted with an amino group or an alkyl group having 1 to 20 carbon atoms, an amino group, a mercapto group, an alkylmercapto group having 1 to 10 carbon atoms, a carboxyalkyl group having an alkyl group with 1 to 10 carbon atoms, an alkoxy group having 1 to 20 carbon atoms or a group formed of a heterocyclic ring; m and n are integers selected so as to satisfy the conditions: m is an integer of 2 or more, n is an integer of 0 or more and m+n=6: and when n is an integer of 2 or more, two or more Xs may be the same or different.

The first and second compositions containing an inorganic particle of the present invention are preferably used for forming an electrode, a dielectric layer or a phosphor layer of a plasma display panel.

Furthermore, the present invention provides a method of formation of an inorganic layer, having a step of providing a layer of a composition containing an inorganic particle, which is formed of the first or second composition containing an inorganic particle of the present invention, on a substrate, and a step of heating the layer of a composition containing an inorganic particle.

According to the method of formation of an inorganic layer of the present invention, a desired inorganic layer can be formed on a substrate with low energy by use of the first or second composition containing an inorganic particle. Furthermore, according to the method of formation of an inorganic layer of the present invention, an inorganic layer reduced in adverse affect derived from organic compounds can be formed.

In the method of formation of an inorganic layer of the present invention, the substrate is a substrate for a plasma display and the inorganic particle is a glass particle, and a dielectric layer for a plasma display can be formed as the inorganic layer.

Furthermore, in the method of formation of an inorganic layer of the present invention, the substrate is a substrate for a plasma display, the inorganic particle is a phosphor particle, and a phosphor layer for a plasma display can be formed as the inorganic layer.

The present invention also provides a dielectric layer for a plasma display formed by the method of formation of an inorganic layer of the present invention and/or a plasma display having a phosphor layer for a plasma display formed by the method of formation of an inorganic layer of the present invention.

Furthermore, the present invention provides a dielectric layer formed by the method of formation of an inorganic layer having a step of providing a layer of a composition containing an inorganic particle, which is formed from the first or second composition containing an inorganic particle, which contains a glass particle as the inorganic particle, on a substrate, and a step of sintering the layer of a composition containing an inorganic particle.

Furthermore, the present invention provides an electrode formed by the method of formation of an inorganic layer of the present invention having a step of providing a layer of a composition containing an inorganic particle from the first or second composition containing an inorganic particle, which contains a metal particle or a metal oxide particle as the inorganic particle, on a substrate, and a step of sintering the layer of a composition containing an inorganic particle.

Furthermore, the present invention provides a phosphor layer formed by the method of formation of an inorganic layer of the present invention having a step of providing a layer of a composition containing an inorganic particle from the first or second composition containing an inorganic particle, which contains a phosphor particle as the inorganic particle, on a back-panel substrate for a plasma display panel, and a step of sintering the layer of a composition containing an inorganic particle.

Furthermore, the present invention provides a plasma display panel having the electrode of the present invention, the dielectric layer of the present invention or the phosphor layer the present invention.

### EFFECT OF THE INVENTION

According to the present invention, it is possible to provide a composition containing an inorganic particle capable of forming a desired inorganic body or an inorganic layer with less energy than ever and capable of reducing an adverse effect derived from organic compounds. Furthermore, according to the present invention, it is possible to provide a method of formation of an inorganic layer using the composition containing an inorganic particle of the present invention and a plasma display having the inorganic layer formed by the method of formation of an inorganic layer of the present invention. Furthermore, according to the present invention, it is possible to form an electrode, a dielectric layer and a phosphor with less energy than ever and to provide a plasma display having the electrode, dielectric layer or phosphor by using the composition containing an inorganic particle of the present invention.

### BRIEF DESCRIPTION OF THE DRAWINGS

FIG. 1 is a schematic sectional view illustrating an embodiment of a method of formation of a dielectric layer according to the present invention.

FIG. 2 is a schematic sectional view illustrating an embodiment of a method of formation of a phosphor layer according to the present invention.

FIG. 3 is a sectional view showing a gist portion of a plasma display panel of the present invention.

FIG. 4 is a graph showing the relationship between the viscosity of a mixture containing tersorb MTPH, a solvent (B) or a solvent (C) and the addition amount of solvent (B) or solvent (C).

### BEST MODES FOR CARRYING OUT THE INVENTION

Preferable embodiments of the invention will be more specifically described below with reference to the drawings as needed. Note that, in the drawings, like reference numerals are used to designate like structural elements and any further explanation is omitted for brevity's sake. Furthermore, dimensional ratios of the drawings are not limited to those shown in the drawings.

<Composition Containing an Inorganic Particle>

The composition containing an inorganic particle according to a first embodiment of the present invention contains an organic compound (A1) (hereinafter sometimes simply referred to as an organic compound (A1)) having a terpene skeleton and a viscosity of 10,000 to 1,000,000 mPa·s at 25° C., and an inorganic particle. Furthermore, the composition containing an inorganic particle of the embodiment may contain a solvent constituted of an organic compound except the organic compound (A1) as long as it does not undermine the effect of the invention.

In the embodiment, it is preferred that isobornyl cyclohexanol represented by the structural formula (1) below is used as the organic compound (A1).

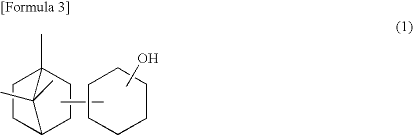

As isobornyl cyclohexanol represented by the above formula (1), “tersorb MTPH” (trade name, manufactured by Nippon Terpene Chemicals, Inc.) is commercially available.

Furthermore, an organic compound (A1) preferably provides a heating residue of not more than 1% by mass, when heated at 300° C. for 10 minutes. Note that the heating is performed in the atmospheric environment. When such an organic compound (A1) is used, an adverse effect derived from the organic compound can be further reduced for the inorganic body obtained by sintering. As the organic compound (A1) that satisfies the above conditions, isobornyl cyclohexanol represented by the above formula (1) is mentioned.

The content of the organic compound (A1) of the composition containing an inorganic particle of the embodiment is preferably 20 to 95% by mass based on the whole amount of composition containing an inorganic particle, more preferably 30 to 90% by mass, further more preferably 40 to 90% by mass, and most preferably 40 to 60% by mass. If the content of the organic compound (A1) falls within the above range, an effect of easily forming a uniform coating film is likely to obtain, compared to the case where the content is outside the range.

Furthermore, in the composition containing an inorganic particle of the embodiment, the content of an organic compound (A1) is 50 to 95% by mass based on the whole amount of organic compounds contained in the composition containing an inorganic particle, preferably 55 to 95% by mass, more preferably 60 to 90% by mass, and particularly preferably 70 to 90% by mass. If the content of an organic compound (A1) falls within the above range, an effect of easily forming a uniform coating film is likely to obtain, compared to the case where the content is outside the range.

As the inorganic particle, which may be appropriately selected depending upon the use of the inorganic body or inorganic layer to be formed, for example, a metal particle, a metal oxide particle, a glass particle and a phosphor particle are mentioned. As the metal particle, gold powder and silver powder are mentioned. Furthermore, to these particles, a glass particle (described later) serving as a binder may be added. As the metal oxide particle, ruthenium oxide, copper oxide, tin oxide and ITO, etc. are mentioned. Furthermore, to these particles, a glass particle (described later) serving as a binder may be added.

The average particle sizes of the metal particle and the metal oxide particle are preferably 0.01 to 20 μm and more preferably 0.1 to 10 μm.

The glass particle preferably has a low melting point and its softening point preferably falls within the range of 300 to 600° C. If the softening point of the glass particle is less than 300° C., the glass particle is melt at the stage where an organic compound (A1) is not completely removed. Because of this, the organic substance remains and is likely to cause a problem such as coloration. On the other hand, if the softening point exceeds 600° C., a problem such as distortion of a glass substrate is likely to occur.

As the glass particle, for example, a plumbic oxide-boron oxide-silicon oxide based (PbO—B₂O₃—SiO₂ based) glass particle; a plumbic oxide-boron oxide-silicon oxide-aluminum oxide based (PbO—B₂O₃—SiO₂—Al₂O₃ based) glass particle; a zinc oxide-boron oxide-silicon oxide based (ZnO—B₂O₃—SiO₂ based) glass particle; a zinc oxide-boron oxide-silicon oxide-aluminum oxide based (ZnO—B₂O₃—SiO₂—Al₂O₃ based) glass particle; a plumbic oxide-zinc oxide-boron oxide-silicon oxide based (PbO—ZnO—B₂O₃—SiO₂ based) glass particle; a plumbic oxide-zinc oxide-boron oxide-silicon oxide-aluminum oxide based (PbO—ZnO—B₂O₃—SiO₂—Al₂O₃ based) glass particle; a bismuth oxide-boron oxide-silicon oxide based (Bi₂O₃—B₂O₃—SiO₂ based) glass particle; a bismuth oxide-boron oxide-silicon oxide-aluminum oxide based (Bi₂O₃—B₂O₃—SiO₂—Al₂O₃ based) glass particle; a bismuth oxide-zinc oxide-boron oxide-silicon oxide based (Bi₂O₃—ZnO-B₂O₃—SiO₂ based) glass particle; and a bismuth oxide-zinc oxide-boron oxide-silicon oxide-aluminum oxide based (Bi₂O₃—ZnO-B₂O₃—SiO₂—Al₂O₃ based) glass particle are mentioned. These are used alone or in combination of two types or more.

The average particle size of the glass particle is preferably 0.01 to 20 μm and more preferably 0.1 to 10 μm.

As the phosphor particle, a phosphor mainly containing a metal oxide is mentioned. As a red-emitting phosphor, for example, Y₂O₂S:Eu; Zn₃(PO₄)₂:Mn; Y₂O₃:Eu; YVO₄:Eu and (Y,Gd)BO₃:Eu are mentioned. As a blue-emitting phosphor, for example, ZnS:Ag; ZnS:Ag, Al; ZnS:Ag, Ga, Al; ZnS:Ag, Cu, Ga, Cl; ZnS:Ag⁺ In₂O₃; Ca₂B₅O₉Cl:Eu²⁺; (Sr, Ca, Ba, Mg)₁₀(PO₄)₆Cl₂:Eu²⁺; Sr₁₀(PO₄)₆Cl₂:Eu²⁺; BaMgAl₁₄O₂₃:Eu²⁺ and BaMgAl₁₆O₂₆:Eu²⁺ are mentioned. As a green-emitting phosphor, for example, ZnS:Cu; Zn₂SiO₄:Mn; ZnS:Cu⁺Zn₂SiO₄:Mn; Gd₂O₂S:Tb; Y₃Al₅O₁₂:Ce; ZnS:Cu, Al; Y₂O₂S:Tb; ZnO:Zn; ZnS:Cu; Al^{+In}₂O₃; LaPO₄:Ce, Tb; and BaO.6Al₂O₃:Mn are mentioned.

The average particle size of a phosphor particle is preferably 0.01 to 20 μm and more preferably 0.1 to 10 μm.

When the composition containing an inorganic particle of the embodiment contains a metal particle or a metal oxide particle as the inorganic particle, the composition containing an inorganic particle becomes suitable for forming an electrode. Furthermore, when the composition containing an inorganic particle contains a glass particle, the composition becomes suitable for forming a dielectric layer. Moreover, when the composition containing an inorganic particle contains a phosphor particle, the composition becomes suitable for forming a phosphor layer.

In the composition containing an inorganic particle of the embodiment, the content of the inorganic particle is preferably 5 to 80% by mass based on the whole amount of composition, in order to improve coating properties to a substrate, more preferably 10 to 70% by mass, further more preferably, 10 to 60% by mass, and most preferably 30 to 50% by mass.

The composition containing an inorganic particle of the embodiment is preferred to further contain a solvent (hereinafter sometimes referred to as a solvent (B)) having a boiling point within the range of 150 to 250° C. in view of flatness of the coating film. Note that, the boiling point of a solvent in the specification refers to a value obtained under the atmospheric pressure.

As the solvent having a boiling point within the range of 150 to 250° C., for example, ketone solvents such as phorone (boiling point: 198° C.), cyclohexanone (boiling point: 155° C.) and methylcyclohexanone (boiling point: 170° C.); ether solvents such as methyl phenyl ether (boiling point: 153° C.), ethyl phenyl ether (172° C.), methoxy toluene (boiling point: 172° C.), benzyl ethyl ether (boiling point: 189° C.), diethylene glycol dimethyl ether (boiling point: 160° C.), diethylene glycol diethyl ether (boiling point: 188° C.), diethylene glycol monomethyl ether (boiling point: 194° C.), diethylene glycol monobutyl ether (boiling point: 231° C.), diethylene glycol monobutyl ether acetate (boiling point: 247° C.), ethylene glycol monobutyl ether (boiling point: 171° C.) and ethylene glycol monoisoamyl ether (boiling point: 181° C.); alcohol solvents such as 1-hexanol (boiling point: 157° C.), 1-heptanol (boiling point: 176° C.), 2-heptanol (boiling point: 160° C.), 3-heptanol (boiling point: 156° C.), 1-octanol (boiling point: 195° C.), 2-octanol (boiling point: 179° C.), 2-ethyl-1-hexanol (boiling point: 184° C.), cyclohexanol (boiling point: 161° C.), 1-methylcyclohexanol (boiling point: 155° C.), 2-methylcyclohexanol (boiling point: 165° C.), 3-methylcyclohexanol (boiling point: 173° C.), 4-methylcyclohexanol (boiling point: 174° C.), furfuryl alcohol (boiling point: 170° C.), ethylene glycol (boiling point: 198° C.), propylene glycol (boiling point: 187° C.), 1,2-butylene glycol (boiling point: 191° C.), hexylene glycol (boiling point: 197° C.) and 3-methyl-3-methoxybutanol (boiling point: 174° C.); acetate solvents such as 3-methoxy-3-methyl-1-butyl acetate (boiling point: 188° C.), ethylene glycol monoacetate (boiling point: 182° C.) and diethylene glycol monobutyl ether acetate (boiling point: 247° C.); cyclic carbonate solvents such as propylene carbonate (boiling point: 241° C.); lactone solvents such as γ-butyrolactone (boiling point: 204° C.); pyrrolidone solvents such as N-methyl-2-pyrrolidone (boiling point: 202° C.); terpene solvents such as α-pinene (boiling point: 156° C.), β-pinene (boiling point: 161° C.), limonene (boiling point: 177° C.), terpineol (boiling point: 217° C.), dihydro terpineol (boiling point: 207° C.) and dihydroterpinyl acetate (boiling point: 220° C.); dimethyl formamide (boiling point: 153° C.) and dimethylsulfoxide (boiling point: 189° C.) are mentioned. These can be used alone or in combination of two types or more.

Of these, compounds having an alicyclic group and a hydroxy group or an ester group, such as cyclohexanol, terpineol, dihydro terpineol and dihydroterpinyl acetate, are preferable. More preferably a terpene solvent such as a terpene alcohol or a terpene ester such as terpineol, dihydro terpineol and dihydroterpinyl acetate is contained. By virtue of this, irregularity such as variation in film thickness, which is caused by temperature distribution of the substrate surface when the composition containing an inorganic particle of the present invention applied onto a substrate is dried, can be reduced without fail.

Terpineol is a mixture of terpineol isomers, namely, α-terpineol, β-terpineol and γ-terpineol, derived from gum turpentine and represented by the formulas below and “terpineol C” (trade name, manufactured by Nippon Terpene Chemicals, Inc.) is commercially available.

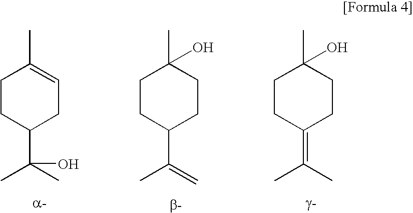

Dihydro terpineol is a hydrogenated compound of terpineol derived from gum turpentine and represented by the formulas below and commercially available from Nippon Terpene Chemicals, Inc.

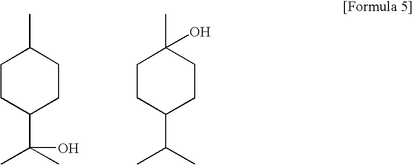

Dihydro terpinyl acetate is a hydrogenated and esterified compound of terpineol, derived from gum turpentine and represented by the formulas below and commercially available from Nippon Terpene Chemicals, Inc.

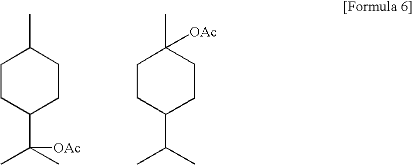

To prevent occurrence of irregularity in a coating film after dehydration, the content of a solvent (B) in the composition containing an inorganic particle of the present invention is preferably 3 to 48% by mass relative to the whole amount of organic compounds (including an organic compound (A1)) contained in the composition, more preferably 3 to 43% by mass, particularly preferably 3 to 38% by mass, and most preferably 8 to 28% by mass.

Furthermore, in the composition containing an inorganic particle of the embodiment, a solvent having a boiling point of less than 150° C. (hereinafter, sometimes referred to as a solvent (C)) may be further contained in order to control dehydration properties of a coating film. Moreover, in the composition containing an inorganic particle of the embodiment, a solvent (C) having a boiling point of less than 150° C. may be used in combination with the solvent (B) in order to not only prevent occurrence of irregularity in a coating film after dehydration but also further reduce the dehydration time of the coating film.

As the solvent having a boiling point of less than 150° C., for example, alcohol organic solvents (methanol, ethanol, isopropyl alcohol, n-butyl alcohol, etc.), aromatic organic solvents (benzene, toluene, xylene, etc.), ketone solvents (acetone, methyl ethyl ketone, methyl isobutyl ketone, etc.), ether solvents (tetrahydrofuran, dioxane, ethylene glycol monomethyl ether, ethylene glycol monoethyl ether), ethyl acetate, methyl propyl diglycol, hexyl carbitol, butyl propylene diglycol, benzyl alcohol, butyl carbitol, DBE thinner (trade name, Du Pont Kabushiki Kaisha), cyclohexane, methyl cyclohexane and cyclohexanone are mentioned.

In the composition containing an inorganic particle of the embodiment, the content of solvent(s), which is not particularly limited, is preferably set such that a mixture with an organic compound (A1) has a viscosity (at 25° C.) of 500 to 50000 mPa·s, more preferably 1000 to 25000 mPa·s and particularly preferably, 1000 to 10000 mPa·s, and further preferably such that the viscosity of the composition containing an inorganic particle falls within the range (described later).

For example, in a composition containing an inorganic particle composed of tersorb MTPH serving as an organic compound (A1) and an inorganic particle, it is difficult to adjust the viscosity thereof to an applicable level. In the circumstances, the viscosity is preferably adjusted by use of a solvent (B) or a solvent (C). However, a solvent that significantly reduces viscosity and has a large viscosity reducing rate is not preferable. This is because such a solvent greatly changes viscosity by a slight difference in addition amount and therefore the viscosity must be accurately controlled. In consideration of easiness of viscosity control, when the viscosity of a composition containing an inorganic particle is controlled by mixing a solvent (B) or a solvent (C), a solvent that reduces viscosity but significantly and has a low viscosity reducing rate even through the addition amount is increased, is preferably selected.

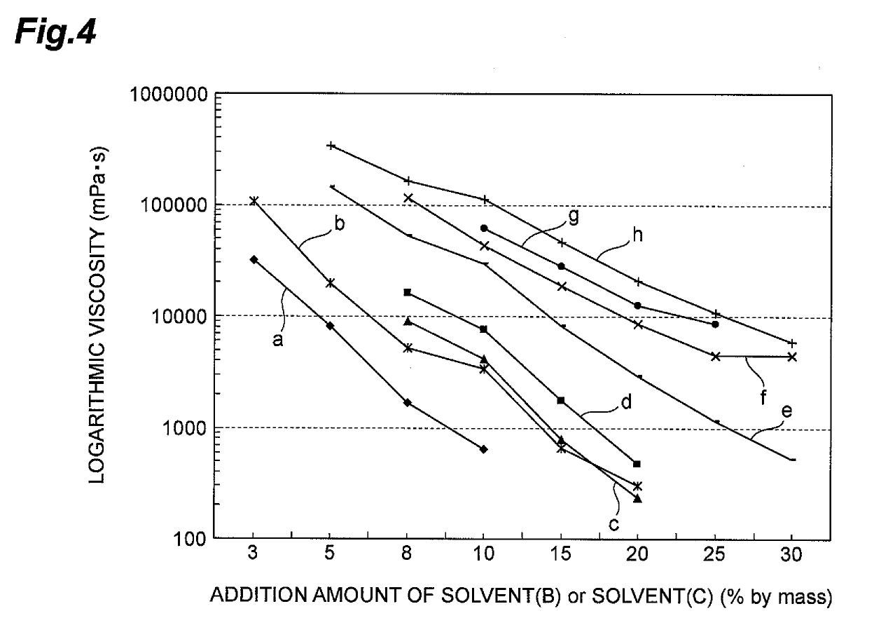

FIG. 4 is a graph showing the relationship between the viscosity (at 25° C.) of a mixture containing tersorb MTPH serving as an organic compound (A1) and a solvent (B) or a solvent (C) and the addition amount of solvent (B) or solvent (C). In this graph, the addition amount of solvent (B) or solvent (C) plotted on the X axis refers to the percentage (% by mass) of the solvent (B) or the solvent (C) to the mixture of tersorb MTPH and the solvent (B) or the solvent (C). Furthermore, in FIG. 4, graphs show viscosity changes of individual mixtures: a in which n-hexane is mixed; b in which diethylene glycol monobutyl ether acetate is mixed; c in which methyl cyclohexane is mixed; d in which cyclohexane is mixed; e in which dihydroterpinyl acetate is mixed; f in which cyclohexanol is mixed; g in which terpineol (“terpineol C”) is mixed; and h in which dihydro terpineol is mixed.

In a mixture of tersorb MTPH and a solvent (C) such as n-hexane, cyclohexane and methyl cyclohexane, when the solvent (C) is added in an amount of about 20% by mass, the viscosity of the mixture is 500 mPa·s or less and a viscosity reducing rate becomes large with an increase of addition amount (indicated by the slope of the graph in FIG. 4). In contrast, in a mixture of tersorb MTPH and a solvent (B), which is a compound or the like having an alicyclic group and a hydroxyl group or an ester group, such as cyclohexanol, terpineol, dihydro terpineol and dihydro terpinyl acetate, even if the solvent (B) is added in an amount of about 30% by mass, the viscosity of the mixture is maintained at 500 mPa·s or more and a viscosity reducing rate is low with an increase of addition amount.

Because of this tendency, of the solvents (B), a compound having an alicyclic group and a hydroxyl group or an ester group, such as cyclohexanol, terpineol, dihydro terpineol and dihydro terpinyl acetate is preferably used in view of easiness of controlling the viscosity. Note that, in the embodiment, a plurality of solvents selected from solvents (B) and solvents (C) can be used in combination to keep easiness of controlling viscosity and controlling dehydration properties of a coating film in balance.

In the case where the composition containing an inorganic particle of the embodiment contains at least one solvent selected from the group consisting of a solvent (B) and a solvent (C), the content of such a solvent is preferably 3 to 30% by mass relative to the whole amount of organic compounds contained in the composition.

Furthermore, it is preferred that the composition containing an inorganic particle of the embodiment further contains a compound represented by the general formula (2) below. In this case, after the coating film of the composition containing an inorganic particle is sintered, the residual weight of the organic compounds can be further reduced.

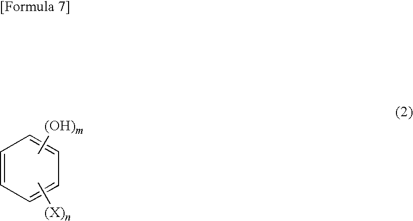

In the formula (2), X represents a halogen atom, a hydrogen atom, an alkyl group having 1 to 20 carbon atoms, a cycloalkyl group having 3 to 10 carbon atoms, an aryl group such as a phenyl group or naphthyl group that may be substituted with an amino group or an alkyl group having 1 to 20 carbon atoms, an amino group, a mercapto group, an alkylmercapto group having 1 to 10 carbon atoms, a carboxyalkyl group having an alkyl group with 1 to 10 carbon atoms, an alkoxy group having 1 to 20 carbon atoms or a group formed of a heterocyclic ring; m and n are integers selected so as to satisfy the conditions: m is an integer of 2 or more, n is an integer of 0 or more and m+n=6: and when n is an integer of 2 or more, two or more Xs may be the same or different.

As the compound represented by the above general formula (2), for example, catechol, resorcinol (resorcin), hydroquinone, alkyl catechols such as 2-methylcatechol, 3-methylcatechol, 4-methylcatechol, 2-ethylcatechol, 3-ethylcatechol, 4-ethylcatechol, 2-propylcatechol, 3-propylcatechol, 4-propylcatechol, 2-n-butyl catechol, 3-n-butyl catechol, 4-n-butyl catechol, 2-tert-butyl catechol, 3-tert-butylcatechol, 4-tert-butylcatechol and 3,5-di-tert-butylcatechol; alkyl resorcinols such as 2-methylresorcinol, 4-methylresorcinol, 5-methylresorcinol (orcin), 2-ethylresorcinol, 4-ethylresorcinol, 2-propylresorcinol, 4-propylresorcinol, 2-n-butylresorcinol, 4-n-butylresorcinol, 2-tert-butylresorcinol and 4-tert-butylresorcinol; alkyl hydroquinones such as methylhydroquinone, ethylhydroquinone, propylhydroquinone, tert-butylhydroquinone and 2,5-di-tert-butylhydroquinone; pyrogallol and phloroglucin are mentioned. Of these, particularly hydroquinone is preferred. These can be used alone or in combination of two types or more.

When a compound represented by the above general formula (2) is used, the content is preferably 0.01 to 10% by mass relative to the whole amount of organic compounds contained in the composition, more preferably 0.05 to 5% by mass, and further more preferably 0.1 to 2% by mass. If the content of a compound represented by the above general formula (2) falls within the above range, the residue weight of organic compounds in the sintered coating film can be more effectively reduced compared to the case where the content is outside the range.

The composition containing an inorganic particle of the embodiment preferably has a viscosity (at 25° C.) of 1000 to 100000 mPa·s, more preferably 2000 to 60000 mPa·s, and particularly preferably 2500 to 50000 mPa·s. When the viscosity of the composition containing an inorganic particle is smaller than 1000 mPa·s, an inorganic particle is likely to precipitate during the storage of the composition containing an inorganic particle. On the other hand, when the viscosity is larger than 100000 mPa·s, the flatness of a coating film tends to decrease.

Furthermore, the organic compounds contained in the composition containing an inorganic particle of the embodiment preferably provide a heating residue of not more than 1% by mass, when heated at 300° C. for 10 minutes.

To the composition containing an inorganic particle of the embodiment, if necessary, for example, an organic binder resin, a dye, a color developer, a plasticizer, a pigment, a polymerization inhibitor, a surface modifier, a stabilizer, an adhesiveness imparting agent and a thermosetting agent can be added, as long as the organic compounds contained in a composition containing an inorganic particle provides a heating residue of not more than 1% by mass when heated at 300° C. for 10 minutes.

However, when an organic binder resin having a weight average molecular weight of 5000 to 1000000 is added, it is difficult for the organic compounds contained in a composition containing an inorganic particle to provide a heating residue of not more than 1% by mass when heated at 300° C. for 10 minutes. Therefore, when an organic binder resin having a weight average molecular weight of 5000 to 1000000 is added, the content thereof is preferably set to 0 to 1% by mass based on the whole amount of organic compounds contained in the composition containing an inorganic particle, more preferably 0 to 0.5% by mass and particularly preferably 0% by mass (that is, not added).

The composition containing an inorganic particle of the embodiment can be prepared, for example, by mixing an organic compound (A1) with a solvent as mentioned above, subsequently adding an inorganic particle as mentioned above and mixing these by a known mixing means.

A composition containing an inorganic particle according to a second embodiment of the present invention contains an organic compound (A2) (hereinafter sometimes simply referred to as an organic compound (A2)) having a viscosity of 10,000 to 1,000,000 mPa·s at 25° C. and providing a heating residue of not more than 1% by mass when heated at 300° C. for 10 minutes, and an inorganic particle, in which the content of the organic compound (A2) is 50% by mass to 95% by mass relative to the whole amount of organic compounds contained in the composition containing an inorganic particle. Furthermore, the composition containing an inorganic particle of the embodiment may contain a solvent except the organic compound (A2) as long as it does not undermine the effect of the invention.

As the organic compound (A2), a terpene compound is preferable and isobornyl cyclohexanol represented by the above formula (1) is more preferable.

In the composition containing an inorganic particle according to the second embodiment, the inorganic particle and the content thereof, the solvent except an organic compound (A2) and the content thereof, and other additives to be contained can be the same as those described in the composition containing an inorganic particle according to the first embodiment.

Furthermore, in the composition containing an inorganic particle according to the second embodiment, the viscosity thereof preferably falls within the same range as that of the composition containing an inorganic particle according to the above mentioned first embodiment.

The composition containing an inorganic particle according to the second embodiment can be prepared, for example, by mixing an organic compound (A2) with a solvent as mentioned above, subsequently adding an inorganic particle as mentioned above and mixing these by a known mixing means.

<Dielectric Layer And Phosphor Layer Formation Method, Dielectric Layer, Phosphor Layer, and Plasma Display Panel (PDP)>

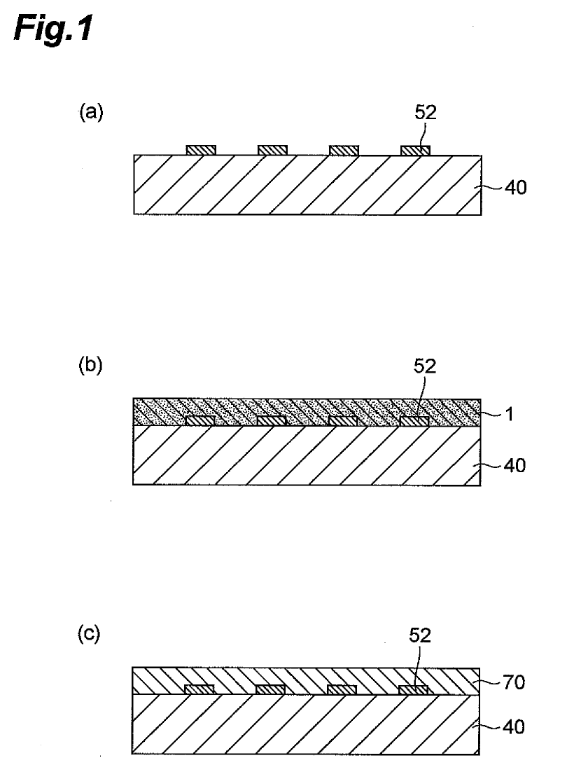

Next, as a specific example of the method of formation of an inorganic layer of the present invention, preferred embodiments of methods for forming a dielectric layer and a phosphor layer will be described. A method of formation of a dielectric layer according to the embodiment has a step of providing a layer of a composition containing an inorganic particle, which is formed of the aforementioned composition containing an inorganic particle of the present invention that contains a glass particle as the inorganic particle, on a substrate, and a step of heating the composition layer. An embodiment of forming a dielectric layer on a front-panel glass substrate constituting a front-panel PDP substrate will be described below, with reference to FIG. 1. FIG. 1 is a schematic sectional view illustrating a method of formation of a dielectric layer of the embodiment.

As shown in FIG. 1 (a), first, a front-panel glass substrate 40 having display electrodes 52 provided thereon is prepared.

Next, as shown in FIG. 1(b), to the front-panel glass substrate 40, at the side having the electrodes 52 provided thereon, a composition containing an inorganic particle of the present invention is applied and dried to form a composition containing an inorganic particle layer 1. In the embodiment, a composition containing an inorganic particle, which contains a glass particle having a low melting point as mentioned above as the inorganic particle, is preferably used. In this case, the composition containing an inorganic particle layer 1 is a glass-containing composition layer.

As a coating method, for example, screen printing, a knife coating method, a roll coating method, a spray coating method, a gravure coating method, a bar coating method, a die coating method and a curtain coating method are mentioned. Dehydration temperature, which is not particularly limited, is preferably 60° C. to 350° C., more preferably 100° C. to 350° C., and particularly preferably 150° C. to 300° C. Dehydration time is preferably about one minute to 2 hours, and preferably about one minute to 1 hour. Note that in this heat dehydration step, not less than 90% by mass of organic compounds is preferably removed, and, not less than 95% by mass is more preferably removed and not less than 99% by mass is particularly preferably removed. In the dehydration step, to reduce the amount of residue of an organic compound and suppress discoloration of an inorganic particle, the oxygen concentration of a heating atmosphere is preferably not more than 10% by volume, and more preferably, 0 to 5% by volume, and particularly preferably 0 to 3% by volume. The oxygen concentration within a heater under natural conditions is the same as the oxygen concentration of air, i.e., about 20% by volume. As a means for reducing the oxygen concentration to not more than 10% by volume, replacing the inner atmosphere of a heater with nitrogen or an inert gas such as argon, helium and neon, using a vacuum pump and others, are mentioned. The value of the oxygen concentration is preferably as low as possible. Oxygen concentration can be easily measured by an oximeter. As a commercially available oximeter, an oximeter LC-750L (manufactured by Toray Engineering Co., Ltd.) and etc. are mentioned.

Next, the composition containing an inorganic particle layer 1 provided on the front-panel glass substrate 40 is sintered to obtain a sintered compact, a dielectric layer 70 (see FIG. 1 (c)). As a sintering method, for example, a method of housing a laminate of a substrate and the above composition containing an inorganic particle layer in an electric furnace and heating it and a method of mounting a laminate on a hot plate and heating it, etc. are mentioned.

Sintering temperature is not particularly limited as long as a composition containing an inorganic particle layer is sufficiently sintered at the temperature. Maximum temperature is preferably 300 to 700° C., more preferably 300 to 600° C., and particularly preferably 400° C. to 600° C. Sintering time is preferably about 5 minutes to 2 hours. Furthermore, sintering is preferably performed in air.

The organic components of a composition containing an inorganic particle layer are vaporized through the above sintering step. In this manner, a dielectric layer formed of inorganic components alone is conceivably formed.

According to the method of formation of a dielectric layer of the embodiment, a composition containing an inorganic particle layer 1 is formed from a composition containing an inorganic particle of the present invention and dried. In this manner, the amount of organic components contained in the composition containing an inorganic particle layer 1 can be reduced than ever at the time of sintering. Thus, a sintering step is completed with less energy to form a good dielectric layer. Furthermore, deposition of decomposition products onto an electric furnace can be sufficiently reduced.

The laminate having a dielectric layer formed on a substrate by the method of formation of a dielectric layer of the embodiment is suitably used as a front-panel PDP substrate (PDP substrate).

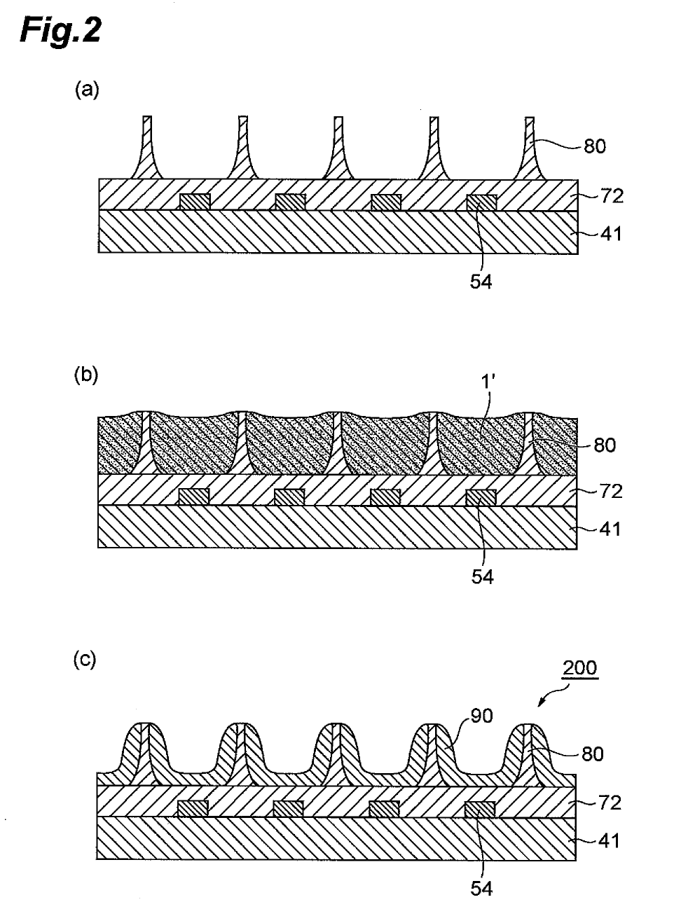

Next, a preferable embodiment of a method of formation of a phosphor layer according to the present invention will be described. A method of formation of a phosphor layer according to the embodiment has a step of providing a composition containing an inorganic particle layer formed from the composition containing an inorganic particle of the present invention that contains a phosphor particle as the inorganic particle, on a substrate, and a step of heating the composition layer. An embodiment of forming a phosphor layer on a back-panel glass substrate for PDP will be described below with reference to FIG. 2. FIG. 2 is a schematic sectional view illustrating a method of formation of a phosphor layer of the embodiment.

First, a back-panel glass substrate 41 having address electrodes 54 formed thereon is prepared. Next, on the back-panel glass substrate 41, at the side having the electrodes 54 provided thereon, a back-panel dielectric layer 72 is formed. On the dielectric layer 72 thus formed, barrier ribs 80 are formed (see FIG. 2 (a)).

Next, in the intervals between adjacent barrier ribs 80, a composition containing an inorganic particle according to the present invention that contains a phosphor particle as the inorganic particle is applied to form a composition containing an inorganic particle layer 1′ (see FIG. 2 (b)).

As a coating method, for example, screen printing, a knife coating method, a roll coating method, a spray coating method, a gravure coating method, a bar coating method, a die coating method, a curtain coating method and a dispenser coating method are mentioned.

Next, the composition containing an inorganic particle layer 1′ is dried and sintered to form a phosphor layer 90 as an inorganic layer (see FIG. 2 (c)).

Dehydration temperature, which is not particularly limited, is preferably about 60 to 200° C. and dehydration time is preferably about one minute to one hour.

As a sintering method, for example, a method of housing a laminate of a back-panel substrate and the above composition containing an inorganic particle layer in an electric furnace and heating it, and a method of mounting the laminate on a hot plate and heating it are mentioned.

Sintering temperature is not particularly limited as long as the organic components in the composition containing an inorganic particle layer are completely removed. Maximum temperature is preferably 300 to 700° C. and more preferably 300 to 600° C. Sintering time is preferably about 5 minutes to 2 hours. Furthermore, sintering is preferably performed in air.

Furthermore, in the method of formation of a phosphor layer of the embodiment, almost whole amount of organic compounds can be removed by heating the composition containing an inorganic particle layer 1′ under the atmosphere (as dehydration conditions) having an oxygen concentration of not more than 10% by volume, preferably 0 to 5% by volume, more preferably 0 to 3% by volume and at a heating temperature of 150 to 350° C., preferably 170 to 300° C. and more preferably 200 to 280° C. In this case, a sintering step can be omitted. Thus, a method of formation of a phosphor layer in a fewer steps can be realized.

In the embodiment, heating is preferably performed under an inert gas atmosphere. Furthermore, heating temperature is preferably about 150 to 300° C. and heating time is preferably about one minute to one hour. As specific conditions, for example, heating at 250° C. for 30 minutes is mentioned.

According to the method of formation of a phosphor layer of the embodiment, the amount of impurities derived from organic compounds contained in a composition containing an inorganic particle layer can be reduced than ever, at the time of sintering. Therefore, a decrease in performance of the phosphor layer 90 caused by remaining impurities derived from the organic compounds can be suppressed. Furthermore, according to the method of formation of a phosphor layer of the embodiment, a sintering step can be omitted. Thus, a method of formation of a phosphor layer in a fewer steps can be realized.

A laminate 200 having a phosphor layer obtained by the method of formation of a phosphor layer of the embodiment can be suitably used as a back-plate PDP substrate (PDP substrate).

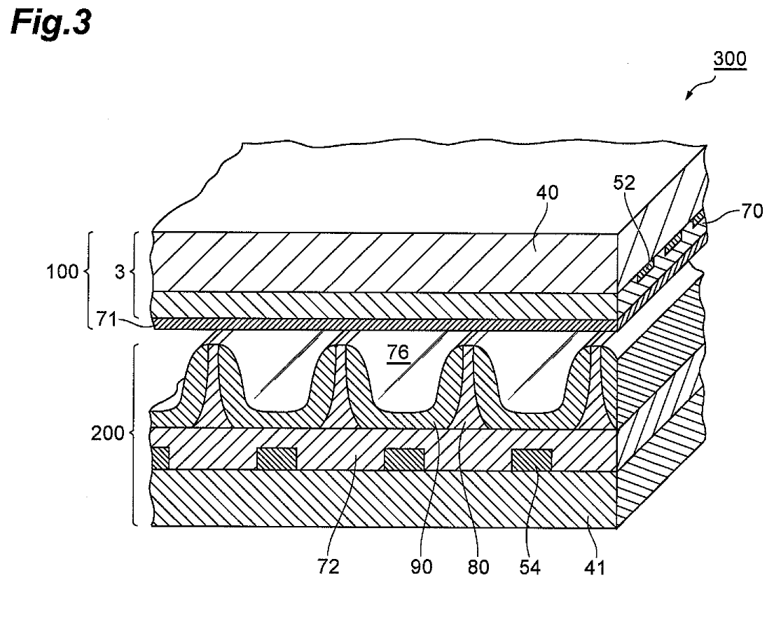

Next, an embodiment of PDP having a dielectric layer and a phosphor layer formed by the method of the embodiment will be described with reference to FIG. 3.

FIG. 3 is a perspective view partly showing an embodiment of PDP according to the present invention. In FIG. 3, PDP 300 is formed mainly of a PDP front-panel 100 and a PDP back-panel 200. The PDP front panel 100 is formed of a laminate 3 and a protecting layer 71 formed so as to cover the surface of a front-panel dielectric layer 70 of the laminate 3. The laminate 3 is formed by sequentially stacking mainly the front-panel glass substrate 40, band-form display electrodes 52 and a front-panel dielectric layer 70. The front panel dielectric layer 70 is obtained by heating the composition containing an inorganic particle layer formed of a composition containing an inorganic particle of the present invention. The PDP back panel 200 is mainly formed of a back-panel glass substrate 41, band-form address electrodes 54 formed on the back-panel glass substrate 41 and the back-panel dielectric layer 72 formed on the back-panel glass substrate 41 and the address electrodes 54, a barrier rib 80 formed on the back-panel dielectric layer 72, and a phosphor layer 90 formed so as to cover the surface of the wall surface of the barrier rib 80 and the surface of the back-panel dielectric layer 72. The phosphor layer 90 is obtained by heating the composition containing an inorganic particle layer formed of a composition containing an inorganic particle of the present invention. Whereas, the PDP front panel 100 and the PDP back panel 200 are allowed to adhere such that the protecting layer 71 and the barrier ribs 80 mutually adhere airtight to form a discharge space 76 surrounded by the phosphor layer 90 and the protecting layer 71. Note that, in the PDP 300, the structural members such as the glass substrates 40, 41, the protecting layer 71, the back-panel dielectric layer 72, the barrier ribs 80 and the electrodes 52, 54 can be formed of materials and method known in the art. The back-panel dielectric layer 72 may be formed by the method of formation of an inorganic layer of the present invention.

The PDP 300 thus constituted is excellent in view of discharge characteristics, manufacturing cost and environment, because the front-panel dielectric layer 70 and the phosphor layer 90 are formed with less energy than ever and sufficiently reduced in adverse effect derived from organic compounds.

Furthermore, in the embodiment, the electrode 52 may be formed by use of a composition containing an inorganic particle of the present invention. In this case, a composition containing an inorganic particle that contains the aforementioned metal particle or metal oxide particle as the inorganic particle is applied onto the substrate 40 to form a composition containing an inorganic particle layer, which is dried and sintered to form the electrodes.

As a coating method, for example, screen printing, a knife coating method, a roll coating method, a spray coating method, a gravure coating method, a bar coating method, a die coating method and a curtain coating method are mentioned. Dehydration temperature, which is not particularly limited, is preferably set to about 60 to 200° C., and the dehydration time is preferably set to about one minute to one hour.

As a sintering method, for example, a method of housing a laminate of a substrate and the composition containing an inorganic particle layer in an electric furnace and heating it, and a method of mounting the laminate on a hot plate and heating it are mentioned.

Sintering temperature is not particularly limited as long as the composition containing an inorganic particle layer is sufficiently sintered. Maximum temperature is preferably 300 to 700° C. and more preferably 300 to 600° C. Sintering time is preferably about 5 minutes to 2 hours. Furthermore, sintering is preferably performed in air.

As described above, the plasma display using PDP having an electrode, a dielectric layer or a phosphor layer formed of the composition containing an inorganic particle of the present invention is excellent in view of display characteristics, manufacturing cost and environment. Particularly, in the case where all of the electrode, dielectric layer and phosphor layer are formed of the composition containing an inorganic particle of the present invention, the plasma display is further excellent in view of display characteristics, manufacturing cost and environment.

### EXAMPLES

The present invention will be more specifically described below by way of examples; however, the present invention is not limited to these examples.

### Preparation of Composition Containing an Inorganic Particle

### Example 1

First, to a flask equipped with a stirrer, a reflux condenser, an inert gas inlet and a thermometer, 77 parts by mass of isobornyl cyclohexanol “tersorb MTPH” (trade name, manufactured by Nippon Terpene Chemicals, Inc.) and 23 parts by mass of “terpineol C” (trade name, manufactured by Nippon Terpene Chemicals, Inc., boiling point: 217° C.) were placed. The mixture was raised in temperature to 80° C. while stirring under a nitrogen atmosphere, and continued to stir while maintaining the temperature at 80° C.±2° C. for 3 hours to obtain a homogenous solution. Thereafter, the reaction mixture was cooled to room temperature and the solution was taken out. The viscosity of the resultant solution at 25° C. was 5700 mPa·s.

Note that the viscosity of tersorb MTPH at 25° C. was 678,000 mPa, the heating residue at 300° C. for 10 minutes was 0.028% by mass. Furthermore, the viscosity of terpineol C at 25° C. was 35 mPa and the heating residue at 300° C. for 10 minutes was 0.020% by mass.

Next, to the solution (57.7 parts by mass) obtained above, a ZnO-B₂O₃—SiO₂—Al₂O₃ based glass frit (42.3 parts by mass) was added, mixed and dispersed by use of a beads mill for 15 minutes. Subsequently, the dispersion solution was filtrated by passing it through a filter cloth having 30 μm-square pores to prepare a solution of the composition containing an inorganic particle of Example 1. The viscosity of the resultant composition containing an inorganic particle solution was 17000 mPa·s at 25° C.

### Example 2

First, to a flask equipped with a stirrer, a reflux condenser, an inert gas inlet and a thermometer, 84 parts by mass of isobornyl cyclohexanol “tersorb MTPH” (trade name, manufactured by Nippon Terpene Chemicals, Inc.) and 16 parts by mass of “terpineol C” (trade name, manufactured by Nippon Terpene Chemicals, Inc., boiling point: 217° C.) were placed. The mixture was raised in temperature to 80° C. while stirring under a nitrogen atmosphere, and continued to stir while maintaining the temperature at 80° C.±2° C. for 3 hours to obtain a homogenous solution. Thereafter, the reaction mixture was cooled to room temperature and the solution was taken out. The viscosity of the resultant solution was 16800 mPa·s at 25° C.

Next, to the solution (57.7 parts by mass) obtained above, a ZnO-B₂O₃—SiO₂—Al₂O₃ based glass frit (42.3 parts by mass) was added, mixed and dispersed by use of a beads mill for 15 minutes. Subsequently, the dispersion solution was filtrated by passing it through a filter cloth having 30 μm-square pores to prepare a solution of the composition containing an inorganic particle of Example 2. The viscosity of the resultant composition containing an inorganic particle solution was 50200 mPa·s at 25° C.

### Example 3

First, to a flask equipped with a stirrer, a reflux condenser, an inert gas inlet and a thermometer, 57 parts by mass of isobornyl cyclohexanol “tersorb MTPH” (trade name, manufactured by Nippon Terpene Chemicals, Inc.) and 43 parts by mass of “terpineol C” (trade name, manufactured by Nippon Terpene Chemicals, Inc., boiling point: 217° C.) were placed. The mixture was raised in temperature to 80° C. while stirring under a nitrogen atmosphere, and continued to stir while maintaining the temperature at 80° C.±2° C. for 3 hours to obtain a homogenous solution. Thereafter, the reaction mixture was cooled to room temperature and the solution was taken out. The viscosity of the resultant solution was 340 mPa·s at 25° C.

Next, to the solution (57.7 parts by mass) obtained above, a ZnO-B₂O₃—SiO₂—Al₂O₃ based glass frit (42.3 parts by mass) was added, mixed and dispersed by use of a beads mill for 15 minutes. Subsequently, the dispersion solution was filtrated by passing it through a filter cloth having 30 μm-square pores to prepare a solution of the composition containing an inorganic particle of Example 3. The viscosity of the resultant composition containing an inorganic particle solution was 1100 mPa·s at 25° C.

### Example 4

First, to a flask equipped with a stirrer, a reflux condenser and a thermometer, 80 parts by mass of isobornyl cyclohexanol “tersorb MTPH” manufactured by Nippon Terpene Chemicals, Inc., and 20 parts by mass of cyclohexanol manufactured by Wako Pure Chemical Industries Ltd. were placed. The mixture was raised in temperature to 60° C. while stirring under a nitrogen atmosphere, and continued to stir while maintaining the temperature at 60° C.±2° C. for 1 hour to obtain a homogenous dispersion solution. Thereafter, the reaction mixture was cooled to room temperature and the solution was taken out. The viscosity of the resultant solution was 8700 mPa·s at 25° C.

Next, to the solution (65 parts by mass) obtained above, 35 parts by mass of a green-emitting phosphor Zn₂SiO₄:Mn (maximum particle size: 15 μm) was added, mixed and dispersed by use of a beads mill for 15 minutes. Subsequently, the dispersion solution was filtrated by passing it through a filter cloth having 30 μm-square pores to prepare the composition containing an inorganic particle of Example 4. The viscosity of the resultant composition containing an inorganic particle was 20200 mPa·s.

### Example 5

First, to a flask equipped with a stirrer, a reflux condenser, an inert gas inlet and a thermometer, 80 parts by mass of isobornyl cyclohexanol “tersorb MTPH” (trade name, manufactured by Nippon Terpene Chemicals, Inc.) and 20 parts by mass of “terpineol C” (trade name, manufactured by Nippon Terpene Chemicals, Inc., boiling point: 217° C.) were placed. The mixture was raised in temperature to 80° C. while stirring under a nitrogen atmosphere, and continued to stir while maintaining the temperature at 80° C.±2° C. for 3 hours to obtain a homogenous solution. Thereafter, the reaction mixture was cooled to room temperature and the solution was taken out. The viscosity of the resultant solution was 18850 mPa·s at 25° C.

Next, to the solution obtained above, hydroquinone (2 parts by mass) was added and mixed by use of a conditioning mixer MX201 (manufactured by Thinky Corporation) for 10 minutes until it was completely dissolved. To the solution (57.7 parts by mass), a ZnO-B₂O₃—SiO₂—Al₂O₃ based glass fit (42.3 parts by mass) was added, mixed and dispersed by use of a beads mill for 15 minutes. Subsequently, the dispersion solution was filtrated by passing it through a filter cloth having 30 μm-square pores to prepare a solution of the composition containing an inorganic particle of Example 5. The viscosity of the resultant composition containing an inorganic particle solution was 43000 mPa·s at 25° C.

### Comparative Example 1

To a flask equipped with a stirrer, a reflux condenser, an inert gas inlet and a thermometer, 92 parts by mass of “terpineol C” (trade name, manufactured by Nippon Terpene Chemicals, Inc., boiling point: 217° C.) was placed. To this solution, ethyl polymethacrylate (8 parts by mass) having a weight average molecular weight of 700,000 and obtained by suspension polymerization method was added while stirring. The mixture was raised in temperature to 120° C. under a nitrogen atmosphere, and continued to stir while maintaining the temperature at 120° C.±2° C. for 3 hours to dissolve ethyl polymethacrylate. Thereafter, the reaction mixture was cooled to room temperature and the resin solution was taken out. The viscosity of the resultant resin solution was 3700 mPa·s at 25° C.

Next, to the solution (55.5 parts by mass, solid matter: 8 parts by mass) obtained above, a ZnO-B₂O₃—SiO₂—Al₂O₃ based glass frit (44.5 parts by mass) was added, mixed and dispersed by use of a beads mill for 15 minutes. Subsequently, the dispersion solution was filtrated by passing it through a filter cloth having 30 μm-square pores to prepare a solution of the composition containing an inorganic particle of Comparative Example 1. The viscosity of the resultant composition containing an inorganic particle solution was 11000 mPa·s at 25° C.

### Comparative Example 2

To a flask equipped with a stirrer, a reflux condenser, an inert gas inlet and a thermometer, 5 parts by mass of isobornyl cyclohexanol “tersorb MTPH” (trade name, manufactured by Nippon Terpene Chemicals, Inc.) and 90 parts by mass of “terpineol C” (trade name, manufactured by Nippon Terpene Chemicals, Inc., boiling point: 217° C.) were placed. To this solution, 5 parts by mass of ethylcellulose 10 cp (manufactured by Wako Pure Chemical Industries Ltd.) was added while stirring. The mixture was raised in temperature to 120° C. under a nitrogen atmosphere, and continued to stir while maintaining the temperature at 120° C.±2° C. for 3 hours to dissolve ethylcellulose. Thereafter, the reaction mixture was cooled to room temperature and the resin solution was taken out. The viscosity of the resultant resin solution was 32000 mPa·s at 25° C.

Next, to the resin solution (55.5 parts by mass, solid matter: 5% by mass) obtained above, a ZnO-B₂O₃—SiO₂—Al₂O₃ based glass frit (44.5 parts by mass) was added, mixed and dispersed by use of a beads mill for 15 minutes. Subsequently, the dispersion solution was filtrated by passing it through a filter cloth having 30 μm-square pores to prepare a solution of the composition containing an inorganic particle of Comparative Example 2. The viscosity of the resultant composition containing an inorganic particle solution was 60000 mPa·s at 25° C.

The viscosity values shown in Examples and Comparative Examples above were measured at 25° C. by E-type viscometer (model number: EHD, manufactured by Told Sangyo Co., Ltd.) at a rotation rate of 20 rpm.

With respect to the composition containing an inorganic particle solutions obtained in Examples 1 to 5 and Comparative Examples 1 to 2, the state of a coating film was evaluated by the following method and a weight change was evaluated by thermogravimetry. The obtained results are shown in Table 2.

[Evaluation for State of Coating Film]

Onto a glass plate, each of the composition containing an inorganic particle solutions of Examples 1 to 5 and Comparative Examples 1 to 2 was applied by use of an applicator (manufactured by Tester Sangyo Co., Ltd.) so as to obtain a wet film thickness of 50 μm and the time of disappearing fluctuation like a citrus skin, which appeared on the coating film surface after coating, was measured. The state of the coating film was evaluated based on the following evaluation criteria:

A: disappeared within 30 seconds (excellent in flatness)
B: disappeared within 1 minute (no problem in flatness)
C: not disappeared within 1 minute (a problem in flatness).

[Evaluation for State of Coating Film after Dehydration]

Onto a glass plate, each of the composition containing an inorganic particle solutions of Examples 1 to 5 and Comparative Examples 1 to 2 was applied by use of an applicator (manufactured by Tester Sangyo Co., Ltd.) up to a wet film thickness of 50 μm to obtain a laminate. Subsequently, these laminates were dried in a dryer of 150° C. for 30 minutes and then the states of coating films were evaluated based on the following evaluation criteria:

A: uniform and flat coating film is formed
B: irregularity of the surface is slightly observed
C: generation of benard cell (irregularity of hexagonal convection cell).

[Evaluation for Heating-Residue of Organic Compound]

Before the inorganic particle of each of Examples 1 to 5 and Comparative Examples 1 to 2 was added to a solution, about 1 g of the solution was weighted on a watch glass made of soda glass having a diameter of 45 mm and a thickness of 2 mm, and dried in a dryer of 300° C. for 10 minutes. The weight of the residue after dehydration was measured, the heating residues of organic compounds were separately calculated in accordance with the following expression:

Heating residue of organic compound(%)=(weight of the solution after heating/weight of the solution before heating)×100

[Thermogravimetry of Coating Film Heated at 300° C. for 10 Minutes]

Onto a glass plate, each of the composition containing an inorganic particle solutions of Examples 1 to 5 and Comparative Examples 1 to 2 was applied by use of an applicator (manufactured by Tester Sangyo Co., Ltd.) up to a wet film thickness of 50 μm to obtain a laminate. Subsequently, these laminates were dried in a dryer of 300° C. for 10 minutes. After dehydration, the coating film of the composition containing an inorganic particle was scratched by a spatula and used as a measurement sample. The weight reduction rate was obtained by thermogravimetry (TG) when the temperature of the sample was raised to 600° C. Note that the value of weight reduction rate, if it is small, indicates that the amount of decomposition products of a composition containing an inorganic particle at the time of sintering is small. As the weight reduction rate decreases, the effect of reducing deposition of decomposition products on the inner wall of an electric furnace, etc. increases. The measurement conditions of thermogravimetry are as follows:

Measuring equipment: TG/DTA-6200 (manufactured by SII NanoTechnology Inc.)

Temperature raising rate: 5° C./min

Measurement temperature: 20 to 600° C.

Atmosphere: in Air, 200 ml/min

Amount of sample: 10 mg

Furthermore, the weight reduction rate was calculated in accordance with the following expression:

Weight reduction rate(%)=[(Measurement-sample weight before raising temperature)−(Measurement-sample weight after raising temperature)]/(Measurement-sample weight before raising temperature)×100 [Expression 1]

[Thermogravimetry of Coating Film Heated at 150° C. for 30 Minutes]

Onto a glass plate, each of the composition containing an inorganic particle solutions of Examples 1 to 5 and Comparative Examples 1 to 2 was applied by use of an applicator (manufactured by Tester Sangyo Co., Ltd.) up to a wet film thickness of 50 μm to obtain a laminate. Subsequently, these laminates were dried in a dryer of 150° C. for 30 minutes. After dehydration, the coating film of the composition containing an inorganic particle was scratched by a spatula and used as a measurement sample. The weight reduction rate was obtained by thermogravimetry (TG) when the temperature of the sample was raised to 600° C. in accordance with the above expression. Note that the measurement conditions of thermogravimetry are the same as those mentioned above.

TABLE 1

| | | | | | | Comparative | Comparative |
|---|---|---|---|---|---|---|---|
| | Example 1 | Example 2 | Example 3 | Example 4 | Example 5 | Example 1 | Example 2 |
| State of coating film | A | A | A | A | A | A | C |
| Evaluation for coating state after | A | A | B | A | A | A | A |
| dehydration | | | | | | | |
| Heating residue (% by mass) of | 0.03 | 0.03 | 0.02 | 0.03 | 0.01 | 5.48 | 3.60 |
| organic compound | | | | | | | |
| (heated at 300° C. for 10 minutes) | | | | | | | |
| <Thermogravimetry of coating film | 0.02 | 0.02 | 0.01 | 0.02 | 0.005 | 6.2 | 4.3 |
| heated at 300° C. for 10 minutes> | | | | | | | |
| Weight reduction rate (% by mass) | | | | | | | |
| <Thermogravimetry of coating film | 1.5 | 1.2 | 1.3 | 1.2 | 1.1 | 10.5 | 6.0 |
| heated at 150° C. for 30 minutes> | | | | | | | |
| Weight reduction rate (% by mass) | | | | | | | |

As shown in Table 2, it is found that a good coating film can be formed and a larger amount of organic components is removed by dehydration, in the composition containing an inorganic particle solutions of Examples 1 to 5 compared to Comparative Examples 1 and 2. Furthermore, as shown in Table 2, it is found that according to the composition containing an inorganic particle solution of Example 5, the amount of heating residue of organic compounds can be further reduced when dehydration is performed at high heating temperature conditions, compared to the composition containing an inorganic particle solutions of Examples 1 to 4. According to the composition containing an inorganic particle solutions of Examples 1 to 5, energy required for sintering can be reduced and the amount of decomposition products deposited in an electric furnace at the time of sintering can be reduced and thereby a burden to the electric furnace is successfully reduced.

### INDUSTRIAL APPLICABILITY

According to the present invention, it is possible to provide a composition containing an inorganic particle capable of forming a desired inorganic body or inorganic layer with less energy than ever and reducing an adverse effect derived from organic compounds. Furthermore, according to the present invention, it is possible to provide a method of formation of an inorganic layer using the composition containing an inorganic particle of the present invention and provide a plasma display having the inorganic layer formed by the method of formation of an inorganic layer of the present invention. Furthermore, according to the present invention, it is possible to provide an electrode, a dielectric layer and a phosphor layer that can be formed with less energy than ever by use of the composition containing an inorganic particle of the present invention, and provides a plasma display having the electrodes, the dielectric layer or the phosphor layer.

1. A composition containing an inorganic particle comprising
an organic compound (A1) having a terpene skeleton and a viscosity of 10,000 to 1,000,000 mPa·s at 25° C., and
an inorganic particle,
wherein a content of the organic compound (A1) is 50% by mass to 95% by mass relative to the whole amount of organic compounds contained in the composition containing an inorganic particle.

2. The composition containing an inorganic particle according to claim 1, wherein the organic compound (A1) is isobornyl cyclohexanol represented by the structural formula (1) below.

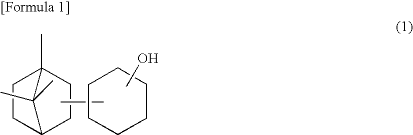

3. The composition containing an inorganic particle according to claim 1, wherein the organic compounds contained in the composition containing an inorganic particle provide a heating residue of not more than 1% by mass when heated at 300° C. for 10 minutes.

4. A composition containing an inorganic particle, comprising
an organic compound (A2) having a viscosity of 10,000 to 1,000,000 mPa·s at 25° C. and providing a heating residue of not more than 1% by mass when heated at 300° C. for 10 minutes, and
an inorganic particle,
wherein a content of the organic compound (A2) is 50% by mass to 95% by mass relative to the whole amount of organic compounds contained in the composition containing an inorganic particle.

5. The composition containing an inorganic particle according to claim 1, further comprising a compound represented by the general formula (2) below: 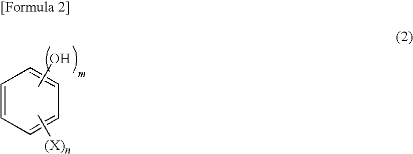
[in the formula (2), X represents a halogen atom, a hydrogen atom, an alkyl group having 1 to 20 carbon atoms, a cycloalkyl group having 3 to 10 carbon atoms, an aryl group that may be substituted with an amino group or an alkyl group having 1 to 20 carbon atoms, an amino group, a mercapto group, an alkylmercapto group having 1 to 10 carbon atoms, a carboxyalkyl group having an alkyl group with 1 to 10 carbon atoms, an alkoxy group having 1 to 20 carbon atoms or a group formed of a heterocyclic ring; m and n are integers selected so as to satisfy the conditions: m is an integer of 2 or more, n is an integer of 0 or more and m+n=6: and when n is an integer of 2 or more, two or more Xs may be the same or different].

6. A method of formation of an inorganic layer comprising
a step of providing a layer of a composition containing an inorganic particle by applying a composition containing an inorganic particle according to claim 1 onto a substrate, and
a step of heating the layer of a composition containing an inorganic particle.

7. The method of formation of an inorganic layer according to claim 6, wherein the substrate is a substrate for a plasma display, the inorganic particle is a glass particle, and a dielectric layer for a plasma display is formed as the inorganic layer.

8. The method of formation of an inorganic layer according to claim 6, wherein the substrate is a substrate for a plasma display, the inorganic particle is a phosphor particle, and a phosphor layer for a plasma display is formed as the inorganic layer.

9. A plasma display comprising a dielectric layer for a plasma display formed by a method of formation of an inorganic layer according to claim 7.

10. A plasma display comprising a phosphor layer for a plasma display formed by a method of formation of an inorganic layer according to claim 8.

11. A plasma display comprising:
a dielectric layer for a plasma display formed by a method of formation of an inorganic layer according to claim 7, and
a phosphor layer for a plasma display formed by a method of formation of an inorganic layer comprising (i) a step of providing a layer of a composition containing an inorganic particle, including (a) an organic compound (A1) having a terpene skeleton and a viscosity of 10,000 to 1,000,000 mPa·s at 25° C., and (b) an inorganic particle, the inorganic particle being a phosphor particle, wherein a content of the organic compound (A1) is 50% by mass to 95% by mass relative to the whole amount of organic compounds contained in the composition containing the phosphor particle, and (ii) a step of heating the layer of the composition containing the phosphor particle.

12. A method of formation of an inorganic layer comprising
a step of providing a layer of a composition containing an inorganic particle by applying a composition containing an inorganic particle according to claim 4 onto a substrate, and
a step of heating the layer of a composition containing an inorganic particle.

13. The method of formation of an inorganic layer according to claim 12, wherein the substrate is a substrate for a plasma display, the inorganic particle is a glass particle, and a dielectric layer for a plasma display is formed as the inorganic layer.

14. The method of formation of an inorganic layer according to claim 12, wherein the substrate is a substrate for a plasma display, the inorganic particle is a phosphor particle, and a phosphor layer for a plasma display is formed as the inorganic layer.

15. A plasma display comprising a dielectric layer for a plasma display formed by a method of formation of an inorganic layer according to claim 13.

16. A plasma display comprising a phosphor layer for a plasma display formed by a method of formation of an inorganic layer according to claim 14.

17. A plasma display comprising:
a dielectric layer for a plasma display formed by a method of formation of an inorganic layer according to claim 13, and
a phosphor layer for a plasma display formed by a method of formation of an inorganic layer comprising (i) a step of providing a layer of a composition containing an inorganic particle, including (a) an organic compound (A2) having a viscosity of 10,000 to 1,000,000 mPa·s at 25° C. and providing a heating residue of not more than 1% by mass when heated at 300° C. for 10 minutes, and (b) an inorganic particle, the inorganic particle being a phosphor particle, wherein a content of the organic compound (A2) is 50% by mass to 95% by mass relative to the whole amount of organic compounds contained in the composition containing the phosphor particle, and (ii) a step of heating the layer of the composition containing the phosphor particle.
